(19) United States
(12) Patent Application Publication
(10) Pub. No.: US 2022/0110277 A1
(43) Pub. Date: Apr. 14, 2022

(54) SYSTEMS AND METHODS FOR HIGH-YIELD HYDROPONIC GARDENING IN CHALLENGING ENVIRONMENTS

(71) Applicant: Levo International, Inc., Bloomfield, CT (US)

(72) Inventors: Mark T. Meyering, Middletown, CT (US); Laurence W. Bassett, Killingworth, CT (US); Denise Fudge, Middlefield, CT (US); Dan Tenney, Madison, CT (US)

(21) Appl. No.: 17/450,832

(22) Filed: Oct. 13, 2021

Related U.S. Application Data
(60) Provisional application No. 63/090,948, filed on Oct. 13, 2020.

(51) Int. Cl. A01G 31/06

(52) U.S. Cl. CPC A01G 31/06

(57) ABSTRACT

Systems, apparatus, methods, and articles of manufacture for hydroponics systems are described. In one embodiment, a containment vessel is provided with a removable cover and/or a separable weir.

### FIELD OF THE INVENTION

The present invention relates to systems and methods for hydroponic agriculture and, more particularly, to improvements in the yield and transportability of tiered hydroponic gardening systems.

### BACKGROUND

Some hydroponic gardening systems having small footprints and high output are known. However, while having some success against intended targets in productivity and reliability for single-family food production, the cost structure of such systems makes them unsuitable for widespread deployment without significant financial subsidies after an initial launch date, or into future markets when funded entirely by the target customer. Typical costs of ownership include transportation, training and setup of a collection of adapted components requiring significant skill, and tooling for proper setup, and such systems may require a difficult maintenance regimen. Despite the importance of food security to users in challenging environments, prior art systems have failed to provide designs that are capable of high yield production and facilitate of use, transportation, and maintenance.

### BRIEF DESCRIPTION OF THE DRAWINGS

An understanding of embodiments described in this disclosure and many of the related advantages may be readily obtained by reference to the following detailed description when considered with the accompanying drawings, of which:

FIG. 1 is pictorial representation of components of a prior art hydroponics system;

FIG. 2A is a perspective view of a removable top cover plate according to an embodiment of the present invention;

FIG. 2B is a perspective view of a trough with separable weir according to an embodiment of the present invention;

FIG. 2C is a cross-section view of a plurality of stackable troughs without installed endcaps, according to an embodiment of the present invention;

FIG. 2D is a longitudinal cross-section view of a plurality of stackable troughs with installed endcaps, according to an embodiment of the present invention;

FIG. 3A is a top plan view of a portion of a hydroponic system according to an embodiment of the present invention;

FIG. 3B is a bottom plan view of a portion of a hydroponic system according to an embodiment of the present invention;

FIG. 3C is a perspective view of a portion of a hydroponic system according to an embodiment of the present invention;

FIG. 3D is a perspective view of a portion of a hydroponic system containing fluid according to an embodiment of the present invention;

FIG. 4A is an elevation view of a removable top plate according to an embodiment of the present invention;

FIG. 4B is an elevation view of a removable top plate and a trough according to an embodiment of the present invention;

FIG. 4C includes cross-section views of a hydroponic system according to an embodiment of the present invention;

FIG. 4D is a perspective view of a hydroponic system according to an embodiment of the present invention;

FIG. 5A is a perspective view of a planted hydroponic system according to an embodiment of the present invention;

FIG. 5B is a perspective view of a planted hydroponic system according to an embodiment of the present invention;

FIG. 5C is a perspective view of a planted hydroponic system according to an embodiment of the present invention;

FIG. 6A is a perspective view of a stand according to an embodiment of the present invention;

FIG. 6B is a perspective view of a registration framework according to an embodiment of the present invention;

FIG. 6C is a perspective view of a hydroponic system according to an embodiment of the present invention; and

FIGS. 7A, 7B, and 7C include a pictorial representation depicting containment of root growth in a hydroponic system according to an embodiment of the present invention.

### DETAILED DESCRIPTION OF THE INVENTION

The present inventive system addresses productivity, reliability, cleanliness, ease of use and cost issues that hamper previous systems, through novel features, advanced manufacturing techniques and use of materials that are heretofore undisclosed in the literature or marketplace. The individual and combined features provide a system with a cost structure that is sustainable in the target market and achieves superior performance in food yield.

In accordance with some embodiments, a hydroponics system is provided that includes one or more of the following features:
a. a containment vessel (e.g., a trough) having a removable cover; and/or
b. wherein the removable cover is configured to substantially cover the opening of the containment vessel and further configured to allow plants to grow through openings in the removable cover; and/or
c. wherein the containment vessels are stackable or nestable with each other (e.g., for ease of transport and/or storage); and/or
d. a removable weir configured to be removably secured in the containment vessel; and/or
e. wherein the removable weir when removably secured in the containment vessel creates with the containment vessel a containment chamber (e.g., in which plants grow and fluids are contained) and a drainage chamber for collecting excess fluid (e.g., fluid that flows over the weir from an upstream containment chamber).

In accordance with some embodiments, hydroponics systems are provided that include one or more of the following features:
a. a trough uniquely structured with
   i. a wide spacing at top for root growth
   ii. a narrower channel at bottom for fluid transport/exchange; and/or
b. reconfigurable cover plates for the trough, pre-indexed with multiple (two or more) tracks across the width in a staggered and/or registered pattern.

According to some embodiments, methods of hydroponic gardening are provided utilizing one or more types of circulating hydroponic systems described in this disclosure, wherein circulation is continuous.

According to some embodiments, methods of hydroponic gardening are provided utilizing one or more types of circulating hydroponic systems described in this disclosure, wherein circulation is intermittent.

In some embodiments, the described trough enables a flexible arrangement of plants per unit tier length, effectively enabling a commensurate multiple (2× or more) of the food output per unit length of the tier and unit area of the system.

In accordance with some embodiments, multiple tiers of trough may be combined in an arrangement to comprise a system. The trough structure requires minimal support elements, is designed for manufacture (DFM), ease of maintenance, and for minimal package size, weight, and cost.

A further beneficial result of the disclosed trough design, in accordance with some embodiments, is nested or stacked component shipment, enabling self-contained safe and protected transport of the system in a single package with minimal packing waste, having all tier components shipped inside nested troughs.

In one or more embodiments, an internal weir structural element is provided to enable effective and simplified fluid management within the trough during daily use for fluid containment (passive) and replenishment (active) cycles required for low maintenance plant growth, as well as an anti-clogging function by benefit of the effectively enlarged aperture of the weir top, providing fluid flow over an unconstricted dam (vs. into a constricted pipe).

In accordance with some disclosed embodiments, further benefits may be realized in ease of setup and use, and ease of maintenance (e.g., removable cover plates allow the exposing of all internal elements for ease of cleaning).

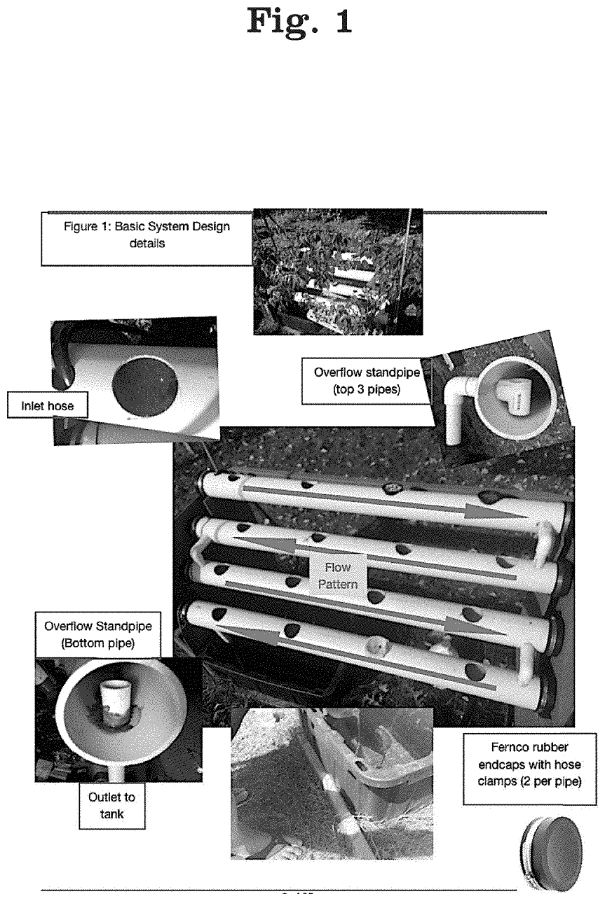

Various embodiments of the disclosed hydroponics system provide solutions to deficiencies in the prior art. The Babylon basic system by Levo International (FIG. 1), for example, is not designed to maximize manufacturing simplicity, is highly labor intensive to build, uses high-cost components, provides no flexibility for reconfiguring hole patterns once drilled, has complex and multi-component fluid transfer between pipes, has many joints requiring full sealing, and remains difficult to clean between uses.

Additionally, a system based on round PVC pipe is bulky to transport, especially if transportation is between country locations (particularly in development and scale up phases). Round pipes do not stack well, and a great deal of air (bulk) is added to shipping cost. The structural framework of plywood and pine studs of the Babylon basic system incorporates a scalloped pattern for ease of alignment and level, but the wood is not a robust exterior grade material for multi-year lifespan of the system. Accordingly the inventors have recognized that it is desirable to use sheet plastic or rigid plastic for a scalloped framework that can collapse for shipment and build-in-place.

Some example specifications for modeling of the new inventive designed system in accordance with some embodiments are provided below. According to one or more embodiments, the geometry and spacing of a (2′×5′) 4-tier 16-plant concept (also utilized in the Babylon basic system prototype) provides a robust and flexible arrangement, suitable for a wide variety of plants important to the farmer in underdeveloped environments. Although the example layout as described in this disclosure is proposed as a practical set of constraints, it will be obvious to one skilled in the art in light of this disclosure that the inventors have also contemplated extension to larger and/or smaller footprints containing the same features, which may result in significant benefit to the target market(s). The example constraints are for illustration, and the inventive concepts are not intended to be limited to any particular physical size and/or tier arrangement.

FIG. 1 depicts an example layout for a basic hydroponics system. As indicated in FIG. 1, a basic hydroponics system may comprise one or more of the following features, which is representative of some prior art systems and may provide a useful hydroponic crop yield:
4 pipe system, numbered 1 to 4 (top to bottom), terraced at chest level (top) to hip level (bottom)
Easy reach to all plants
4 root cup holes (e.g., 2-inch diameter) per pipe spaced at equal intervals
Hole pattern staggered every other pipe to minimize interference with mature plant canopy of neighbor pipe
Overhead arrangement to provide rain canopy and/or shade option
Overhead arrangement for support (wire, string) to tie vertical supports to growing plant height
Superstructure for stability and maintain plumb & level pipes
Option to bury nutrient container for temperature control
Color: White (reflect heat), Opaque (eliminate sunlight—algae formation)
Arrangement to pump (or withdraw) from container tank to inlet of pipe 1 per circulation schedule
Arrangement (stand-pipe) to maintain fluid level in pipe when circulation stops
Arrangement for channel overflow into next pipe
Gravity flow from feed—to—drain at opposite end of pipe, alternating flow direction every other pipe
Drain from pipe 4 directly to container tank
Means to access tank for replenish water, straining floaters, sampling liquid, measure pH, TDS, temperature
Fluid maintenance and processing:
   Contain nominally 30 gallons of nutrient fluid (nutrient level will be adjusted over plant life cycle)
   Store bulk of nutrient in covered tank, (partially buried in the Haitian ground for temperature control)
   Circulation: Intermittent (4×/day) a volume sufficient to exchange the static volume of the 4 pipes, nominally 5 gallons through pipe system at a rate not to exceed 1 gallons per minute (gpm). Deliver by hand pump, bucket elevation, or by continuous pumping at trickle rate of 40 gallons per day (gpd) minimum.
   Stand-pipes to maintain a level of fluid which is equivalent at each point of the system, @ 2.75-inch+/−0.25-inch depth
   No leaks—closed system
   Root Cup hole covers provided for plants pulled out (disease or spent pants), to minimize algae and mosquitoes

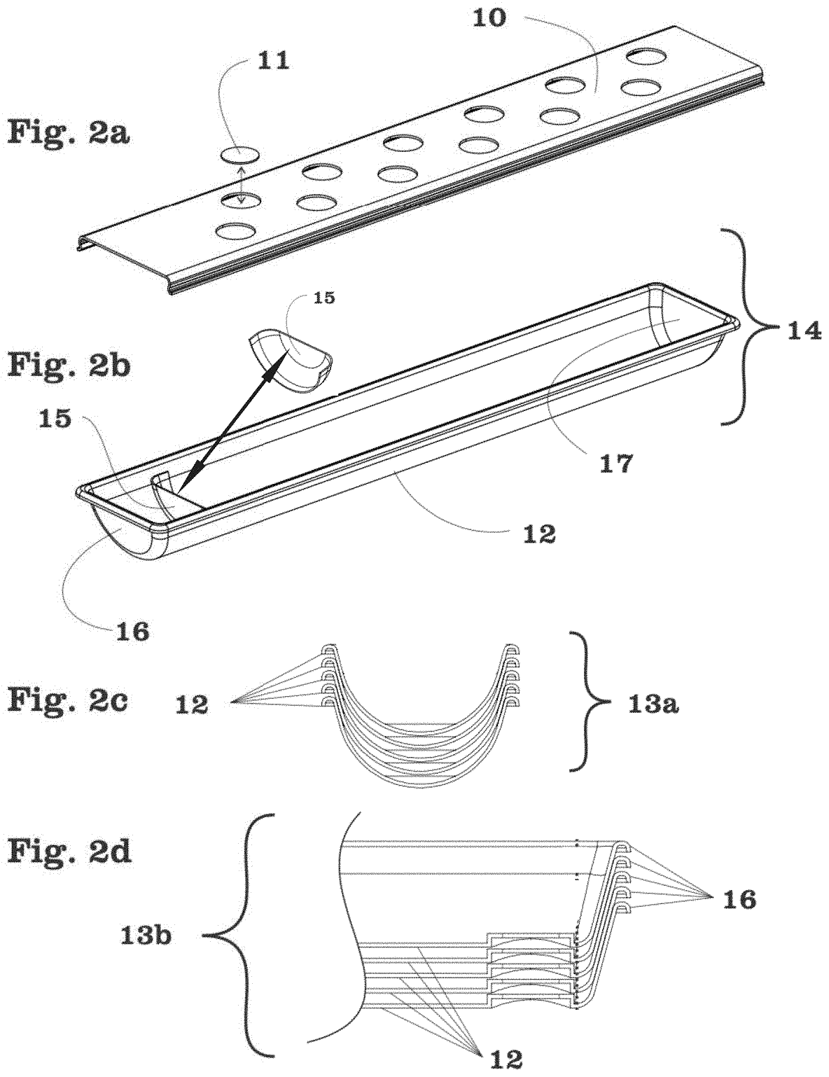

The present inventive hydroponics system is comprised of specific departures from the basic system, while maintaining, in accordance with some embodiments, a tiered arrangement and user-friendly instruction set for operation. Some example inventive solutions for hydroponic systems are depicted in FIGS. 2A-2D, 3A-3D, 4A-4D, 5A-5C, 6A-6C, and 7A-7C.

In some example embodiments, the proposed inventive system may utilize an open top trough, plus flat top plates for hole patterns to cover the trough. Top plates will snap on and snap off the trough. When the top plate is snapped off or otherwise removed, the whole trough may be accessible for cleaning in between cycles. The flat plates can be drilled or punched with a hole pattern and swapped for (or reconfigured to) different patterns when needed, without affecting the physical integrity of the trough.

In accordance with some embodiments, pre-punched knock-out discs may be provided that can be re-inserted as needed to block unused portions of the trough (as required for selective harvesting; i.e., removing mature and unproductive, or diseased plants).

As depicted in FIG. 1, some prior art basic systems require an arrangement of stand-pipes and tees to create and maintain a fluid level. In contrast, in accordance with some embodiments of the present invention, a trough draining end capping assembly may comprise a weir feature, to maintain fluid level in the trough and direct the spillover to conduct fluid to lower levels. The inventive weir may resemble a flat dam that is not a closed orifice like a pipe; this has the advantage of reduced clogging potential from extended root growth out of the terminal plant in the flow pattern of any single trough.

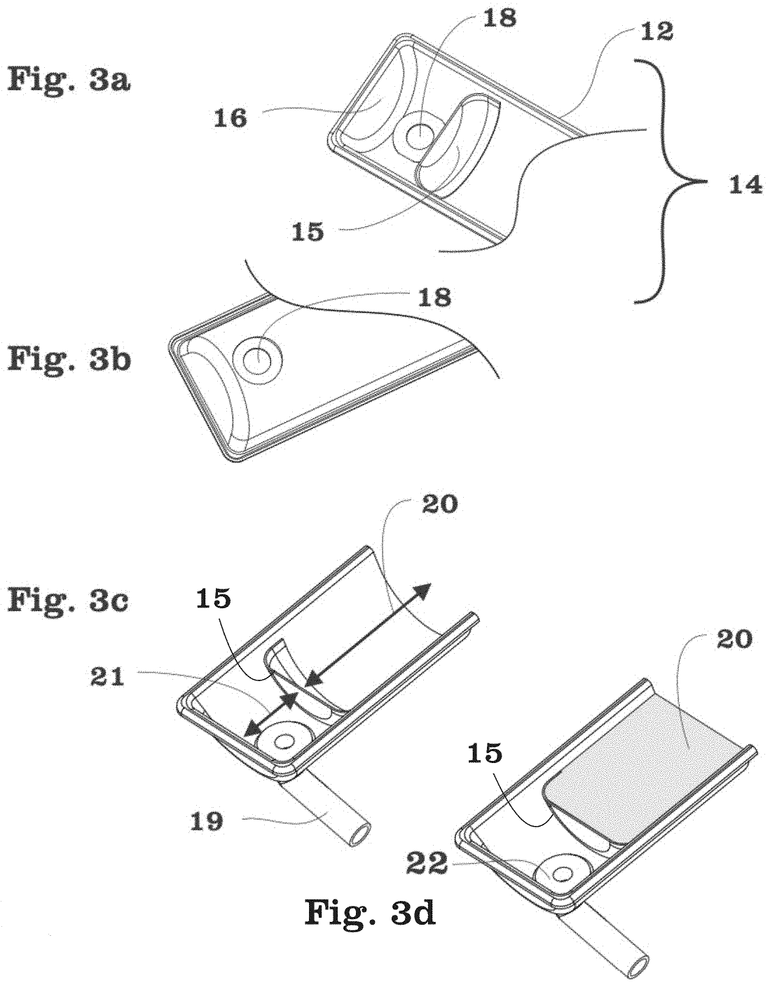

In accordance with some embodiments (see, e.g., FIGS. 3A-3D), at least one downspout arrangement may be attached just beyond the weir feature (e.g., weir 15 of FIG. 3D), conducting fluid downward to the next trough, to a holding tank, or as desired for a particular implementation.

In accordance with one embodiment, the weir may be inserted and welded or otherwise affixed to the trough prior to use. In another embodiment, the weir may be removably securable to the trough (e.g., a snap in—snap out feature) while remaining leak-proof when installed. In some embodiments, the weir is configured to create an effective watertight seal with the trough in which it is installed; in this way, the weir can beneficially contain nutrient fluid upstream of the weir without seepage or leakage under and/or around the sides of the dam for extended periods of time.

In one embodiment, the weir has a fixed height optimal for root growth, containment, and minimal clogging of channel. Alternately, the weir can provide an adjustable height (e.g., from half trough height to full trough height) to accommodate different needs of the root between seedling phase, growth phase, and mature phases of plants.

According to some embodiments, a small collection area beyond the weir may contain a single outlet and the aforementioned downspout (see, e.g., drainage hole 18 and downspout 19 of FIGS. 3B and 3C). The downspout is preferably arranged to communicate with the next lower trough (or ground-based containment vessel). In one embodiment, the downspout and endcap comprises a single piece of molded plastic that is sealed on (or snaps on) the downstream end of the trough. With intermittent use, the collection area will be completely emptied between pumping cycles, therefore the need to create a watertight seal at the point of connection to the trough may be less important. With continuous use, the collection area will have a low hold-up volume, immediately emptying into the next lower trough or tank. The low volume may be effectively served with a substantially watertight seal to the trough at only the bottommost area of collection area containment.

In another embodiment, the weir, collection area, downspout and endcap may be formed of a single molded piece that is sealed to the end of the trough prior to use. Preferably, such an arrangement is removable and resealable between plant growing cycles.

As described with respect to some embodiments, it may be beneficial to allow detached (non-sealed) transport within the nested trough(s) during shipping. For this reason, in some embodiments the downspout and weir may be removable parts from the weir-collection-endcap section.

According to some embodiments, the structural framework may be a rigid plastic system, holding troughs at opposite ends in plumb and parallel register. Legs to the registration feature may comprise rigid plastic or galvanized pipe members, preferably in a snap together system with structural safety fastener features (bolt or clip).

As discussed in this disclosure, various aspects of the present invention allow for various combinations and arrangements of components for a desired implementation. FIG. 2A shows an example removable top cover plate (10) (also referred to in this disclosure as a “top plate”) having a flexible arrangement of knock-out discs (11) that when removed create holes for insertion of root cups (not shown). The top plate 10 is configured to engage with a trough or other containment vessel (e.g., trough (12) of FIG. 2B). In FIG. 2B, an individual trough 12 is shown, assembled with example weir (15) and example endcaps (16, 17).

FIG. 2C depicts an example of how troughs may be nested or stacked for storage or storage. As shown in FIG. 2C, multiple troughs 12, with endcaps and weir removed, may be stackable in a nesting arrangement (13a) for shipping or storage. FIG. 2D depicts a different example stackable nesting arrangement (13b) with troughs (12) and endcaps (16) preassembled but without a weir installed. Endcaps (17) may be similarly attached to the troughs 12 in this example configuration but are not shown in FIG. 2D.

In accordance with some embodiments, a number of weirs (15) may be packed loosely in the top trough of a set of nested troughs for shipping or storage purposes.

FIG. 3a depicts a partial view of a fully assembled trough of a hydroponics system (14). The assembled trough comprises trough (12), weir (15), endcap (16) and drainage hole (18) which empties to a downspout (19).

This example arrangement creates two chambers within the trough that are divided by the weir 15: the larger upstream containment chamber (20) for maintaining a nutrient liquid level for root nourishment and growth, and the smaller downstream drainage chamber (21) for collection of overflow liquid during circulation. The example configuration of the weir 15 in the trough 12 advantageously confines roots to the upstream containment chamber 20 and excludes roots from the drainage chamber (21) and downspout (19).

According to one example embodiment, the downspout 19 is mechanically sealed to the bottom of the drainage chamber by means of a nominal seal arrangement (22) at the drainage hole (18).

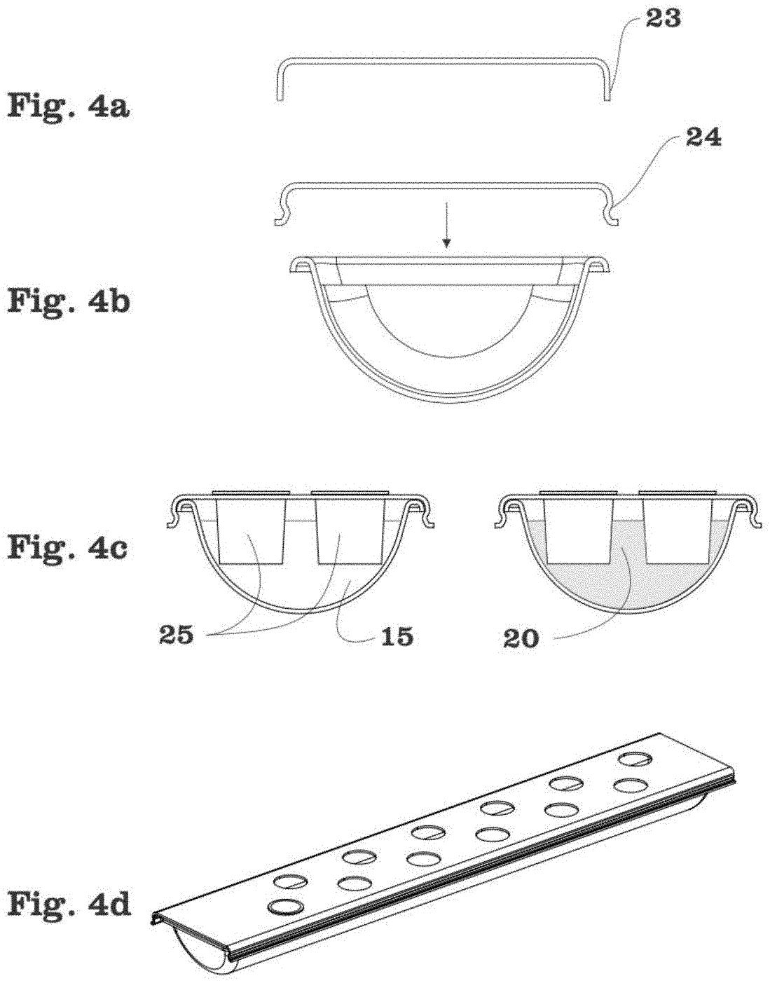

FIGS. 4A-4D provide a detailed representation of examples of enabled novel arrangements comprising a combination of top plate and assembled trough. FIG. 4A shows a simplified example arrangement in which an example top plate 23 is designed to provide a slip fit connection to a trough (not shown). Top plate 23 is configured with a substantially straight lip.

FIG. 4B shows an example arrangement where an alternative top plate 24 is contoured at the lip to provide a physical snap-on/snap-off feature for additional structural security of the connection with a trough.

Referring now to FIG. 4C, root cups (25) can be dropped into knock-out holes in a top cover (e.g., holes 11 of top cover 10), and will dip into the upstream containment chamber 20 to a level determined by the height of the weir 15. In FIG. 4C, the example height of the weir (15) is nominally set to cover at least half the depth of a root cup 25. This height and the resulting fluid volume of upstream containment chamber (20) can be fixed or varied to accommodate any required dip level, as needed.

Note that the example hydroponics system of FIG. 4D as shown is nominally 9 inch width at the top plate, thus nominally 9 inch diameter at the trough opening. This dimension is not intended to be limiting. A practical width is envisioned between 6 inches or less and 12 inches or greater. The nominal length of trough and top plate in the examples as shown is 5 feet; likewise envisioned to be flexible, from 3 feet or less to 10 feet or greater in certain embodiments. The wall thickness of the plastic material in the example is roughly 0.1875 inches, where thin sections are favored to reduce weight and cost; but routine experimentation is expected to optimize the trade-off between robust beam strength in conditions of use and component cost. A practical component wall thickness is envisioned between 0.10 inches or less and 0.25 inches or greater, in certain embodiments.

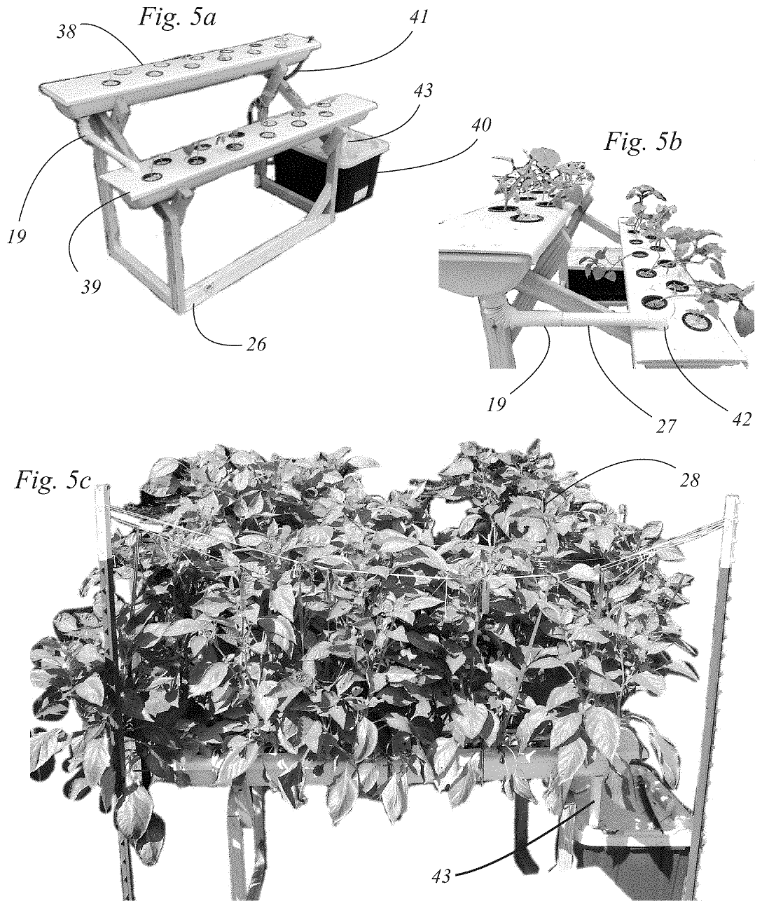

FIGS. 5A-5C provide a pictorial representation of a two-tier example system of the present invention, built to the nominal dimensions of assembled trough components shown and described in FIGS. 4A-4D, using a top plate style like that of top plate 23 of FIG. 4A. This system was loaded with a monoculture of green pepper plants. FIG. 5A is a perspective angle on the front after initial seedling introduction in root cups, where the system is supported by a simple frame (26). A nutrient container tank (40) is filled and occasionally refilled as needed with hydroponic nutrient, comprised of water and soluble fertilizer components. A small submersible pump (not shown) inside the tank conducts the nutrient up through a hose (41) to the upper top trough assembly (38), which fills the containment chamber of the top tier.

FIG. 5B is a side view showing a flexible tube downspout (19) with a downspout extension (27) between tiers. The extension is terminated by a right angle elbow penetrating the top of the lower tier cover plate into a fill hole (42). This fills the containment chamber of the lower tier (39). On the drainage end of the lower tier is a second downspout, here labeled (43) on FIG. 5A. The downspout conducts the recirculated fluid back into the containment tank to create a substantially closed system.

FIG. 5C is a front view of the maturing canopy plant growth (28) after approximately eight weeks growth The second downspout (43) is more clearly visible in this image.

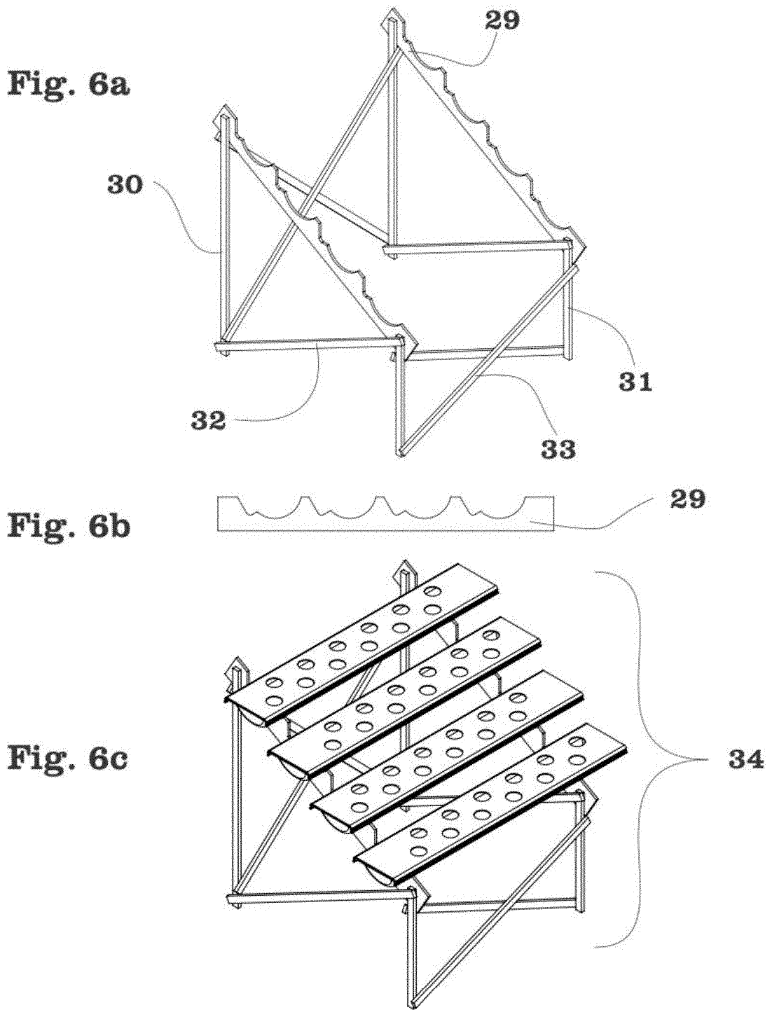

Referring now to FIG. 6A, an example four-tier hydroponics system is shown. The example system comprises registration framework 29, which is shown in a side elevation view in FIG. 6B. Registration framework 29 is configured in the system to affix spacing and leveling of troughs (shown in FIG. 6C, described below).

FIG. 6A shows a representative assembly of structural components. The registration framework is supported by rear legs (30), front legs (31), side braces (32) on both sides and cross braces (33) on front and rear. All structural components, when disassembled, are able to be nested into the hollow of a disassembled trough stack (see, e.g., stack 13 of FIG. 2C) for compact shipment.

FIG. 6C shows the relationship between the structural components and the troughs as a partial assembly (34), ready for final fluid connections and service. These structural components may be modified to accommodate two to four tiers, and may be expanded to greater than four tiers as needed.

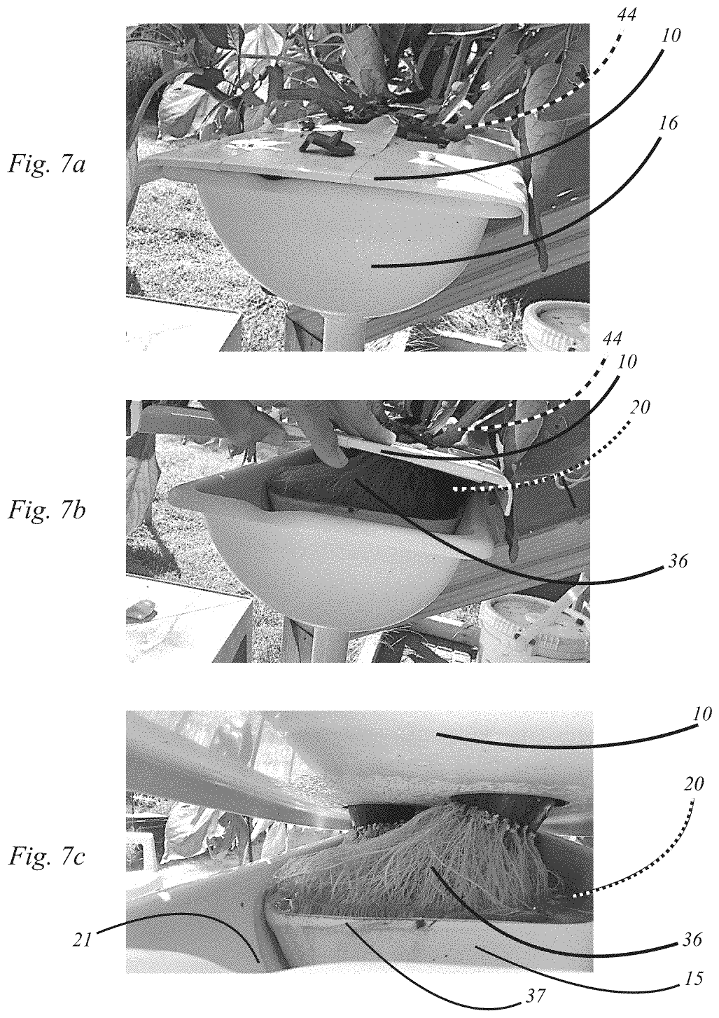

FIG. 7 is a pictorial demonstration of the function of the weir 15 in preventing root clogging of the downstream drainage plumbing in a working trough assembly. FIG. 7A is an exterior view facing the drainage endcap (16) of the same bottom trough shown in FIG. 5C.

In FIG. 7B, the top cover plate (10) is lifted during the operation of the system. The termination point of the upstream containment chamber (20) of the bottom trough is visible. FIG. 7B shows the root system (36) of the nearest plant (44) to the bottom trough drainage chamber.

FIG. 7C is an image taken with the camera positioned at the edge of the drainage chamber (21), showing the shape and growth patterns of the root system lifted for inspection from its normal growing position. The root system (36) has formed entirely in the upstream containment chamber (20) of nutrient liquid. The circulating excess liquid (37) is spilling over the weir 15 in a substantially linear flow pattern across the top of the weir 15, into the downstream drainage chamber 21. Advantageously, there is no root overgrowth topping the weir 15 in the depicted example, and no penetration of root into the drainage chamber (21) or drain plumbing below.

The following paragraphs describe some advantages of the disclosed design solutions in according with some example embodiments.

1—Flexible arrangement of plants per unit pipe (trough). The snap-on top plate provides flexibility in hole patterns. Since the top plate is not tasked with fluid containment, it can be produced from a substantially flat sheet, using a potentially thinner gauge of plastic than the structural trough, and therefore consuming less plastic material and requiring less machining/processing (i.e. a less expensive component). Top plates are replaceable and reconfigurable, depending on the plant mix used on a given trough. As received, plates can be pre-drilled, or provided with knock-outs (partially punched holes that can be individually snapped out or left in place). The knock-outs are provided in a staggered pattern that allows a 50% increase, or with a double track staggered pattern, up to 100%, (double) the number of plants per unit length, or with a triple track staggered pattern, up to a 150% increase (triple) the number of plants per unit length. Higher multiples are possible based on width of the upper portion of trough. The flexibility is provided to enable a higher overall yield, and a more robust plant mix. For example, a higher number of holes per unit length will be more useful for plants that do not require large horizontal spacing in a row; but many important plants are more “vertical’ (certain lettuce, Epinah, jalapeno pepper varietals, etc). Guidance for plant spacing may be provided in training. The knock-outs will serve double duty; they can be retained and replaced over a hole to seal the hole when a root cup is removed mid-season. This will address a system management issue that is currently jury-rigged or ignored in the field. Snap-on and snap-off features (such as indents, bosses or indexed mating patterns can be integrated into either the top plate, the upper surfaces of the trough, or both.

2—Major advantage of the trough systems are ease of transport and system delivery in challenging environments. Four troughs will stack efficiently and rigidly into a single trough. The design will minimize the shipping footprint. Structural framework components will nestle into the top trough, for compactness in shipping. Above the trough, 4 full length flat plates with knockout hole patterns pre-stamped into the plates are stacked together and laid on top. The lowest plate in the stack will snap into the top trough for rigidity during shipping. The top trough will contain the framework components. In this manner, the troughs plus top plate stack will comprise their own shipping container, with a minimal wrap of cling plastic for secure containment of shipped parts. Assembly will be done on-site by the end-use customer, with included parts and visual work instructions.

3—Ease of cleaning. The fluid containment features of the trough system are fully exposed after snapping off the top, for hot water or chemical sanitization, or for vigorous scrubbing with simple soap and scouring pad. Exposure ensures an easy visual confirmation of an effectively cleaned system.

4—Anti-clogging feature: the weir and collection chamber provide protection against root clogging of an orifice.

The following paragraphs describe some examples of inventive features (and example combinations of such features) and systems.

1—The inventive design elements of trough and plate, with staggered plate hole patterns arranged in parallel staggered tracks down the length. In one embodiment, there are two tracks, enabling the opening of as few as 4 through as many as 8 holes per 5-foot section. In a 4-tier system, this would provide (as examples) 4×4, or 4×6, or 4×8 (or any count in-between) plants per system. This provides a flexible arrangement of plants per unit pipe (trough). The snap-on top plate provides the flexible arrangement of hole patterns. Top plates are replaceable and reconfigurable, depending on the plant mix used on a given trough. As received, plates will be pre-drilled, or will be provided with knock-outs (partially punched holes that can be individually snapped out or left in place). In the present embodiment, the knock-outs are provided in the parallel staggered pattern that allows up to 100%, (double) the number of plants per unit length when compared to the basis Babylon basic system. In yet another embodiment, a wider opening at the top of the trough could be designed, which would enable three tracks of staggered plate hole patterns arranged in parallel. This in turn would provide as few as 4 or as many as 12 holes per 5 foot section. The flexibility is provided to enable a more robust plant mix. A higher number of holes per unit length will be more useful for plants that do not require large horizontal spacing in a row; but many important plants are more “vertical’ (certain lettuce, Epinah, jalapeno pepper varietals, etc). Guidance for plant spacing will be provided in operator training. The knock-outs will serve double duty; they can be retained and replaced over a hole to seal the hole when a root cup is removed mid-season. This will address a system management issue that is currently jury-rigged or ignored in the field. The enabling feature of a wide opening at top of trough will ensure that each plant (no matter where placed across the length and width of the top plate) will have equal immersion depth of root cups at all points, equal access to fluid and equal root expansion possibility within a track. Although not wishing to be bound by theory, it is proposed that root expansion space at top is a desirable feature in hydroponics, since the constraints of a circular cross section (as in 4″ PVC pipe) forces the top of the root to conform with restrictions on both sides of the hole, and forces root growth lower into the channel, increasing the possibility of local clogging of channel. Root expansion at the point of entry of the root cup is desirable, creating a surface lawn of substantially less restricted root grown at the high water point, and leaving the lower portion of the the “U” shaped or “V” shaped (or intermediate hybrid shape) channel open for unrestricted flow and nutrient exchange during flow events. These beneficial arrangements in the channel are proposed (in theory) to be enabling to stronger and faster root growth, more rapid upper plant development, and less plant energy expended on root conformation to pipe features.

2—Simplified level control, fluid transport, failsafe containment with Anti-clogging feature: the weir and collection chamber provides protection against root clogging of an orifice. An internal weir structural element is provided to enable effective and simplified fluid management within the trough during daily use for fluid containment (passive) and replenishment (active) cycles required for low maintenance plant growth, as well as an anti-clogging function by benefit of the effectively enlarged aperture of the weir top, providing fluid flow over a unconstricted dam (vs. into a constricted pipe).

3—nutrient sachet using teabag or non woven web containment of locally sourced NPK extracting substances (manure, shell, porous rock or sand, mined micronutrient) may be advantageously used to provide nutrient ion fertilizer in a time release manner, further reducing material and operating costs.

4—A method of source local water analysis for calcium, magnesium, sulfur, potassium and other beneficial ionic elements required for plant grown can be performed, for determination of adequacy of said ions in a hydroponic feedwater, such that a secondary addition of optimized nutrient additive blend may be predetermined and adjusted to exclude the analyzed quantities of hard water elements that are replenished via local water make-up additions; providing additional economy of fertilizer addition for optimal plant growth.

5—A prophylactic oxygen bubbler system for root O₂ replenishment in the feedwater for use in tropical environment (high temperature) can be provided to mitigate plant root disease.

In some embodiments, the inventive system and components may be constructed from engineering plastic materials that are robust against the environment, in relatively thin sections. Thin cross sections of support components (for example, the trusses and legs comprised of round, square, or rectangular shaped in cross sections) are expected to provide strength, while being less likely to fail in high wind due to their low surface area. Optimal shape and dimension of any structural component may be determined by routine engineering analysis finding the proper balance between strength, cost, and shape for prevention of blow-down during high wind events. The system may be constructed, alternatively, from formed metals such as coated aluminum, steel, galvanized metals or other form-able construction materials known to those familiar with the art. Plastic or metal forming machines can be advantageously set up and operated in-country, as desired. Plastic raw material (i.e. resin beads or powder) can be globally sourced for cost containment. Suitable plastics include but are not limited to: PVC, High Density Polyethylene, Polypropylene, Polyamide (Nylon) and other materials known in the art. Structural plastics for framing and support members may advantageously contain fillers, UV stabilizers, colorants or molding agents.

Structural plastics for hydroponic fluid contact may be selected to conform to regulatory guidance in country, as required. In the absence of an in-country regulatory system, USDA and NSF regulatory restrictions for potential food contact, for example, may be observed in plastic selection for wetted surfaces.

Various embodiments of the invention have advantages over previously-known hydroponics systems. Traditional soil based gardening is the standard in developing world economies, having the lowest cost of entry and the highest customer acceptance. Productivity of this method is the basis by which new gardening systems are judged. Soil gardening is highly labor intensive in dry climates, requiring frequent watering events that are especially difficult in drought conditions, where sourced water requires foot travel to a local town well, pump station, river, creek or other containment body. Typical transport of water is effected by use of nominally 5-gallon polyethylene or polypropylene buckets repurposed from other uses (food service packaging, paint, industrial liquids, etc.). These buckets are typically balanced and carried on the farmer's head, most typically on women's and children's heads. A 5-gallon load weighs nominally 40 pounds and is carried various distances relative to garden proximity to the source. Distances of 3 to 5 miles over uneven paths are not uncommon. Water waste at point of use in gardening is a factor, where diffusion into the parched ground and away from the plant can significantly reduce the immediate uptake, and the staying power of the water in the vicinity of the root. In times of drought, the plants may require multiple treatments in the course of a day.

The primary advantage of hydroponics is the economy of water use, which is captured and contained in the plumbing and containment vessel; not lost to diffusion into soil. Water savings are significant over the life cycle of the plant, approaching a lox reduction in total water need. This results in collateral savings of time and energy of the individual farmer and family, and is highly desirable.

The size of the hydroponic system is a factor as well. The family farmer in the developing world may not have an abundance of arable land, and a significant percentage of families have not adopted farming at all due to the relatively tiny plots of land under their direct control, on which they can site a garden.

The specific advantages of the present novel system over available hydroponic solutions include system cost and high density yield in a minimal system footprint. The Babylon footprint has been field tested. The market data has verified that the Babylon basic family system is properly sized to gain traction in the 3rd world due to its favorable footprint. The basic Babylon system has provided the basis for entitlement food production, and would be widely accepted in country if the system could be obtained at a sustainable cost, with assurance of achievement of the target entitlement food yield. The present novel system is expected to meet or exceed the entitlement food yield of a Babylon system at a lower cost and with higher reliability.

Competitive systems are nonexistent in the third world due to first-world pricing and non-existent distribution, sales and support models. The LEVO business system and processes described herein are proposed to provide the necessary business model(s).

A prophetic example for a 4-tier novel system as described in the present invention will deliver an output food yield of at least about 20% greater than a basic system, up to at least about 50% greater than a basic system, with at least 90% reliability in the first growing cycle, when operated in accordance to LEVO instructions. Reliability is expected to improve further with training and support, plus continuing experience of the operator.

### Example 1: Elimination of Root Clogging Using the Present Inventive System

As previously mentioned, the problem of root clogging in plumbing systems for hydroponic gardening is well known. A closed system having fluid transport between growth chambers (such as the commonly used 4-inch or 6-inch PVC pipe as a growth chamber) relies on smaller diameter piping, for pumping, draining, filling, etc., operations. Especially at the drain ports, closed hydroponic systems of the prior art are highly susceptible to root clogging of the plumbing drain connections between growth chambers, or from growth chamber to fluid containment tanks, where a restriction to a smaller diameter drain exists. Roots from plants in the upstream chambers will typically grow and spread in an unrestricted manner into the downstream plumbing. This results in clogged plumbing systems, reducing or substantially eliminating the replenishment of fresh hydroponic nutrient, which harm the health, viability and productivity of the plants.

A test system of the present invention was built and tested in a two-tier configuration, as described with respect to FIGS. 5A-5C. The test system was loaded with green pepper seedlings and placed into service. Growth and plant health were assessed after eight weeks. The effectiveness of the separation by means of the test weir between the larger upstream containment chamber for maintaining a nutrient liquid level for root nourishment and growth, and the smaller downstream drainage chamber for collection of overflow liquid during circulation while confining root to the upstream chamber and excluding root from the drainage chamber and downspout was tested.

FIGS. 7A-7C provide a pictorial demonstration of the effectiveness of the test weir in preventing root penetration and root clogging of the downstream drainage chamber in a working trough assembly. FIG. 7A is an exterior view facing the drainage endcap (16) of the same bottom trough shown in FIG. 5C after significant growth of the plants have occurred, eight weeks past root cup immersion with seedling. In FIG. 7B, the top cover plate (10) is lifted during the operation of the system. Referring briefly to FIG. 5A and FIG. 5B, nutrient fluid flow is in progress by means of the immersion pump inside the container tank (40) providing a continuous flow of replenishing nutrient liquid from the container tank (40), conducted by a hose (41) to the top trough (38). Flow is cascading from the top trough (38) to its downstream collection chamber, which in turn drains into the the inlet end and upstream containment chamber of the bottom trough (39). In FIG. 7B, the termination point of the upstream containment chamber (20) of the bottom trough is visible. FIG. 7B shows the root system (36) of the nearest plant (44) to the bottom trough drainage chamber. The root system had been undisturbed for the entire growth cycle; i.e. no attempt had been made to trim the roots or provide any treatment to the roots. The nearest plant's root system has the highest potential of contributing to root clogging at the drain. FIG. 7C is an image taken with the camera positioned at the edge of the drainage chamber (21), showing the shape and growth patterns of the root system lifted for inspection from its normal growing position. The root system (36) has formed entirely in the upstream containment chamber (20) of nutrient liquid. The circulating excess liquid (37) was found to be spilling over the weir in accordance to the design in a substantially linear flow pattern across the top of the weir, into the downstream drainage chamber. There was no root overgrowth topping the weir, and no penetration of root into the drainage chamber (21) and drain plumbing below. The combined effect of separating the chambers in the trough system by means of the weir feature effectively prevents root clogging of downstream components.

In accordance with some embodiments, novel business systems are provided for creative micro-financing, local (in-country) manufacture of components and system assembly, plus local (regional) distribution models and local (kiosk) component and consumable supplies and service, which in turn create new employment and economic opportunities through value-added processes in the target 3rd world economic environment. These business systems in aggregate create a sustainable economic model for the local growth, of low-cost high-yield hydroponic food security systems.

1. A hydroponics system comprising:
a containment vessel; and
a weir configured to be secured in the containment vessel.

2. The hydroponics system of claim 1, further comprising:
a removable cover configured to be removably attached to the containment vessel to substantially cover an opening of the containment vessel.

3. The hydroponics system of claim 2, wherein the removable cover comprises at least one opening for plant growth.

4. The hydroponics system of claim 1, wherein the weir, when secured in the containment vessel, creates with the containment vessel a containment chamber for plant growth and a drainage chamber for collecting excess fluid.

5. The hydroponics system of claim 1, further comprising:
at least one additional containment vessel, each additional containment vessel having a respective weir.

6. The hydroponics system of claim 5, wherein each additional containment vessel has a respective removable cover.

7. The hydroponics system of claim 5, wherein the trough shape is configured for nesting the plurality of containment vessels.

8. The hydroponics system of claim 1, further comprising:
a downspout configurable with the containment vessel to allow fluid to drain from the containment vessel.

9. A hydroponics system comprising:
a trough unit containing an upstream growth chamber;
a downstream drainage chamber; and
a removable and resealable top cover plate for the trough unit.

10. The hydroponics system of claim 9, the top cover plate having a staggered plate-hole pattern arranged in parallel staggered tracks down its length.

11. The hydroponics system of claim 9, wherein the upstream growth chamber and the downstream drainage chamber are separated by a fluid tight weir installed in the trough.

12. A hydroponics system comprising:
a trough,
a fluid tight weir installed in the trough, and
a drainage tube downstream of the fluid tight weir.

13. The hydroponics system of claim 12, wherein a height of the fluid tight weir is adjustable from half full to full trough volume.

14. (canceled)

15. The hydroponics system of claim 1, further comprising:
a nutrient replenishment means comprising a porous controlled release sachet extraction arrangement containing soluble nutrient.

16. The hydroponics system of claim 9, further comprising:
a nutrient replenishment means comprising a porous controlled release sachet extraction arrangement containing soluble nutrient.

17. The hydroponics system of claim 12, further comprising:
a nutrient replenishment means comprising a porous controlled release sachet extraction arrangement containing soluble nutrient.

18. The hydroponics system of claim 12, further comprising:
a removable cover configured to be removably attached to the containment vessel to substantially cover an opening of the containment vessel.

19. The hydroponics system of claim 18, wherein the removable cover comprises at least one opening for plant growth.

20. The hydroponics system of claim 18, wherein the removable cover comprises a staggered plate-hole pattern.
